(19) United States
(12) Patent Application Publication
(10) Pub. No.: US 2024/0257411 A1
(43) Pub. Date: Aug. 1, 2024

(54) POSE ESTIMATION FOR IMAGE RECONSTRUCTION

(71) Applicant: QUALCOMM Technologies, Inc., San Diego, CA (US)

(72) Inventors: Gabriele CESA, Diemen (NL); Arash BEHBOODI, Amsterdam (NL); Taco Sebastiaan COHEN, Amsterdam (NL); Max WELLING, Bussum (NL)

(21) Appl. No.: 18/159,622

(22) Filed: Jan. 25, 2023

Related U.S. Application Data
(60) Provisional application No. 63/267,225, filed on Jan. 27, 2022.

(51) Int. Cl. G06T 11/00; G06T 5/00; G06T 5/10; G06T 5/50; G06T 7/70

(52) U.S. Cl. CPC G06T 11/005; G06T 5/002; G06T 5/10; G06T 5/50; G06T 7/70; G06T 11/008; G06T 2207/10056; G06T 2207/20084; G06T 2207/30004

(57) ABSTRACT

Certain aspects of the present disclosure provide techniques for pose estimation for three-dimensional object reconstruction. In one example, a method, includes receiving image data, wherein the image data comprises a plurality of images taken from varying poses; identifying one or more pairs of spatially related images within the plurality of images; generating a synchronization graph indicative of at least one similarity metric between the plurality of images, based at least in part on the identified one of more pairs of spatially related images; and estimating a pose of an object depicted in the plurality of images based on the synchronization graph.

### CROSS-REFERENCE TO RELATED APPLICATIONS

This application claims benefit of and priority to U.S. Provisional Application No. 63/267,225, filed Jan. 27, 2022, which is assigned to the assignee hereof and hereby expressly incorporated by reference in its entirety as if fully set forth below and for all applicable purposes.

### INTRODUCTION

Aspects of the present disclosure relate to pose estimation for image reconstruction.

Reconstructing three-dimensional (3D) shapes from two-dimensional (2D) image data is an inherently complex problem. This complexity is increased when the 2D data is noisy and the projection directions (e.g., the pose of both the image and the imager) are unknown. Nevertheless, such reconstructions are critical to various imaging technologies, such as, but not limited to, Cryo-Electron Microscopy (Cryo-EM) and other medical imaging techniques.

### BRIEF SUMMARY

Certain aspects provide a method, includes receiving image data, wherein the image data comprises a plurality of images taken from varying poses; identifying one or more pairs of spatially related images within the plurality of images; generating a synchronization graph indicative of at least one similarity metric between the plurality of images, based at least in part on the identified one of more pairs of spatially related images; and estimating a pose of an object depicted in the plurality of images based on the synchronization graph.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts examples of cryo-EM images at different signal-to-noise values.

FIG. 2 depicts an example generation process of cryo-EM images.

FIG. 3 depicts a table with a summary of the cryo-EM symmetries.

FIG. 4 depicts an example process for image pose estimation from image data.

FIG. 5 depicts an example method for pose estimation of image data.

FIG. 6 is a block diagram illustrating a processing system which may be configured to perform aspects of the various methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for estimating pose for image reconstruction.

The methods described herein are generally applicable to any sort of image reconstruction task in which 2D image data generated by a tomographic projection is used to generate 3D models of objects. Throughout this disclosure, Cryo-Electron Microscopy (Cryo-EM) is used as one example use case, but note that the methods described herein are applicable in many imaging and reconstruction contexts.

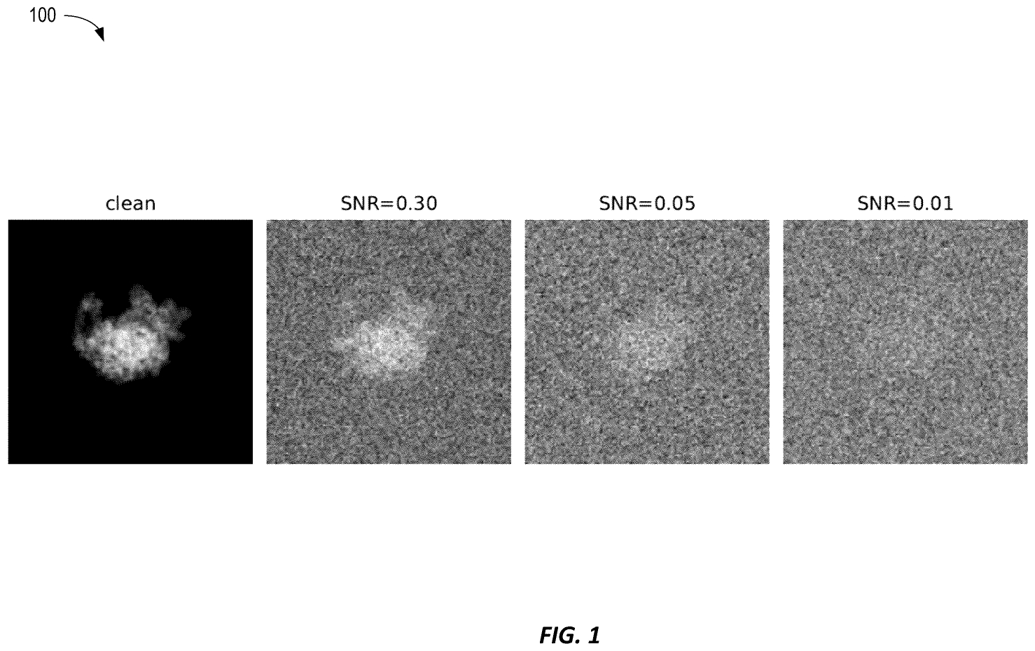

Cryo-EM is an important imaging method which allows high-resolution reconstruction of the 3D structures of biomolecules. In single-particle cryo-EM, a purified solution containing a molecule of interest is frozen on a thin film and then bombarded with electrons to obtain a 2D tomographic (integral) projection of it. The resulting image contains the projection of each copy of the molecule in the solution; in a particle picking phase, these projections are cropped to obtain a dataset of 2D projections. Since each copy in the solution is randomly rotated in 3D, each image is a projection of the molecule's density in a random unknown pose. The objective is reconstructing the molecule's 3D structure from these observations. Unfortunately, the produced images are characterized by a very low signal-to-noise ratio (SNR). FIG. 1 depicts an example of cryo-EM images 100 at different SNR values that demonstrates how the high noise and the unknown poses make this problem particularly challenging.

Thus, cryo-EM produces highly noisy 2D images by projecting a molecule's 3D density from random viewing directions. Because the projection directions are unknown, estimating the images' poses is an important step to perform the reconstruction. Aspects described herein approach this problem from the group synchronization framework; that is, if the relative poses of pairs of images can be approximated from the data, an estimation of the images' poses is given by the assignment which is most consistent with the relative ones. In particular, by exploiting symmetries in image data (and in this case of cryo-EM image data), it can be shown that relative poses in the group O(2) provide sufficient and necessary constraints to identify the images' poses for reconstruction, and in the context of cryo-EM, up to the molecule's chirality. To do so, aspects described herein provide significant advantages over conventional multi-frequency vector diffusion maps (MFVDM) methods by using O(2) relative poses. Aspects described herein not only predict the similarity between the images' viewing directions, but also recover their poses. Hence, all input images in a 3D reconstruction algorithm can be leveraged by initializing the poses with the estimation, rather than just clustering and averaging the input images as in conventional methods. However, in certain cases, the relative poses available may not be sufficient to fully constrain the absolute poses, resulting in a set of equivalent solutions which includes both correct and incorrect solutions. This including of both correct and incorrect solutions creates ambiguity. The use of relative O(2) poses may help remove this ambiguity, ensuring all equivalent solutions are correct.

### Initial Notes on Notation

Let SO(2) be the group of planar rotations, O(2) the group of planar rotations and reflections, SO(3) the group of 3D rotations and O(3) the group of 3D rotations and mirroring.

In the context of the cryo-EM example, a molecule's 3D density is a function Ψ: [symbol] ³→ [symbol] ∈L²( [symbol] ³) with compact support around the origin of [symbol] ³. An observation is a gray-scale image generated by the integral projection along the Z axis Π: L²( [symbol] ³)→L²(R²), which is defined as:

$$\prod ( Ψ ) ( x , y ) = {\int }_{z} Ψ ( x , y , z ) dz x , y , z ∈ ℝ .$$

In particular, the image of oᵢ∈L²( [symbol] ²) is the projection of a copy of the molecule Ψ rotated by a random gᵢ⁻¹∈SO(3), thus:

$${o}_{i} := \prod ( {g}_{i}^{- 1} \cdot Ψ ) \qquad ( 1 )$$

where the action of SO(3) on L²( [symbol] ³) is the standard action:

$$[ g \cdot Ψ ] ( x ) := Ψ ( {g}^{- 1} \cdot x ) ∀ g ∈ S O ( 3 ) .$$

An element gᵢ∈SO(3) is identified with a real orthonormal matrix (xᵢ, yᵢ, zᵢ)∈ [symbol] ^{3×3} with positive determinant. The three orthonormal vectors xᵢ, yᵢ, zᵢ∈ [symbol] ³ form a basis for [symbol] ³. Using this, oᵢ can be expressed as:

$${o}_{i} ( x , y ) = \prod ( {g}_{i}^{- 1} Ψ ) ( x , y ) = {\int }_{z} Ψ ( x {x}_{i} + y {y}_{i} + z {z}_{i} ) dz .$$

In particular, note that if gᵢ=(xᵢ, yᵢ, zᵢ), then zᵢ ∈ [symbol] ³ is the viewing direction along which Ψ was projected while xᵢ and yᵢ define the rotation of the camera around this axis. Given an element g=(x, y, z)∈SO(3), the projection map may be defined as π(g)=z∈ [symbol] ³.

One of the main challenges in cryo-EM is the fact that the pose gᵢ∈SO(3) of each observation oᵢ is unknown. This prevents one from gluing the observations together to reconstruct the density Ψ. However, the set of observations {oᵢ}ᵢ can be used to estimate the relative poses {gᵢⱼ=gⱼ⁻¹gᵢ}ᵢⱼ. Given an estimation of the relative poses, the goal is now to “synchronize” them, i.e. find a global assignment of the poses {ĝᵢ}ᵢ consistent with the estimated relative poses such that:

$${\hat{g}}_{j} \approx {\hat{g}}_{i} {g}_{i j}^{- 1} ∀ i , j . \qquad ( 2 )$$

Note that, if {ĝᵢ}ᵢ is a solution, so is {gĝᵢ}ᵢ for any g∈SO(3). However, this ambiguity is not unexpected and corresponds to the fact that any rotated molecule g⁻¹. Ψ is an equally valid reconstruction, i.e. cryo-EM may be unable to recover the orientation of a molecule.

### Estimating the Relative Poses of Similar Images

Before solving the synchronization problem, it is necessary to estimate the relative poses {gᵢⱼ=gⱼ⁻¹gᵢ}ᵢⱼ. Unfortunately, since the projection Π loses information about the 3D structure, it may not be possible to estimate the relative pose of any pair of images. However, when the viewing directions π(gᵢ)=zᵢ and π(gⱼ)=zⱼ of two images are sufficiently close, they may differ only by a planar rotation rᵢⱼ∈SO(2) which can be directly estimated as

$${r}_{i j} = arg {min}_{r ∈ SO ( 2 )} {o}_{j} - r \cdot {o}_{{i}_{2}^{2}} s . t . π ( {g}_{i} ) \approx π ( {g}_{j} ) . \qquad ( 3 )$$

where r acts on image oᵢ by rotating it. The closer zᵢ and zⱼ are, the better rᵢⱼ approximates gᵢⱼ. Indeed, if zᵢ=zⱼ, then gᵢⱼ=gⱼ⁻¹gᵢ has form:

$$[ \begin{matrix}* & * & 0 \\ * & * & 0 \\ 0 & 0 & 1 \\ & & \end{matrix} ] ,$$

where the top-left 2×2 block is an SO(2) matrix. All the rotations of this form may be identified as the subgroup SO(2)≅R_{z}<SO(3) of planar rotations around the Z axis. The projection operator Π is SO(2)-equivariant, i.e.:

$$\prod ( r \cdot Ψ ) = r \cdot \prod ( Ψ ) ∀ r ∈ {R}_{z} ≅ S O ( 2 ) . \qquad ( 4 )$$

Hence, if gⱼ⁻¹=rgᵢ⁻¹, it follows that oⱼ=r·oᵢ. However, this approach does not provide sufficient information to precisely estimate the poses {gᵢ}ᵢ of the images. Indeed, the estimated relative rotations {rᵢⱼ∈SO(2)}ᵢⱼ yield the following constraints on the absolute poses:

$${\{ {g}_{i} \}}_{i} : {g}_{j} \approx {g}_{i} {r}_{ij}^{- 1} ∀ i , j .$$

Since SO(2) is abelian, if {ĝᵢ}ᵢ is a solution to this set of constraints, then {ĝᵢr}ᵢ is an equally valid solution for any r∈R_{z}≅SO(2):

$${\hat{g}}_{j} \approx {\hat{g}}_{i} {r}_{ij}^{- 1} {\hat{g}}_{j} r \approx {\hat{g}}_{i} {r}_{ij}^{- 1} r {\hat{g}}_{j} r \approx ( {\hat{g}}_{i} r ) {r}_{ij}^{- 1} .$$

This implies that any method that estimates the poses {gᵢ}ᵢ from the estimated relative ones {rᵢⱼ∈SO(2)}ᵢⱼ may only be able to recover them up to a global rotation r∈R_{z}. This global ambiguity prevents using these estimations to directly invert the linear projection Π and recover the original molecule Ψ.

Nevertheless, the ambiguous poses {gᵢr}ᵢ still contain information about the viewing direction of the projections. Indeed, note that π(gᵢr)=π(gᵢ), i.e. the viewing directions are invariant to this global ambiguity and, therefore, can be recovered from this method. In other words, SO(2) relative poses estimated from the images may be used to estimate the viewing directions of the images, but are not sufficient to recover the full pose of the image (e.g., the rotation of an ideal camera around the viewing direction).

In contrast to conventional VDM-based 2D classification methods, aspects of the present disclosure provide techniques to estimate poses rather than clustering and averaging images, without degradation of noise robustness properties. In aspects described herein, the global SO(2) ambiguity problem is solved by directly estimating the absolute poses {gᵢ}ᵢ of the images. To do so, another symmetry of the image data generative process (e.g., cryo-EM in this example) may be exploited.

### Aspects Related to the Cryo-EM Synchronization Problem

The tomographic projection II is also invariant to mirroring along the Z axis

$${m}_{z} = [ \begin{matrix}1 & 0 & 0 \\ 0 & 1 & 0 \\ 0 & 0 & - 1\end{matrix} ] ∈ 0 ( 3 ) i . e . : \prod ( {m}_{z} \cdot Ψ ) = {\int }_{z} Ψ ( x , y , - z ) dz = {\int }_{z} Ψ ( x , y , z ) dz = \prod ( Ψ ) .$$

This additional symmetry may be useful to break the global SO(2) symmetry explained earlier.

First, let

$${r}_{y} = [ \begin{matrix}- 1 & 0 & 0 \\ 0 & 1 & 0 \\ 0 & 0 & - 1\end{matrix} ] ∈ SO ( 3 )$$

be a π rotation along the Y axis; note that r_{y}=m_{z}mₓ, where mₓ is a mirroring along the X axis. Then, let

$$f = [ \begin{matrix}- 1 & 0 \\ 0 & 1\end{matrix} ] ∈ O ( 2 )$$

be the flip of a planar image along the X axis. Then:

$$Π ( {r}_{y} . Ψ ) = Π ( {m}_{z} {m}_{x} . Ψ ) = Π ( {m}_{x} . Ψ ) = f . Π ( Ψ ) , \qquad ( 5 )$$

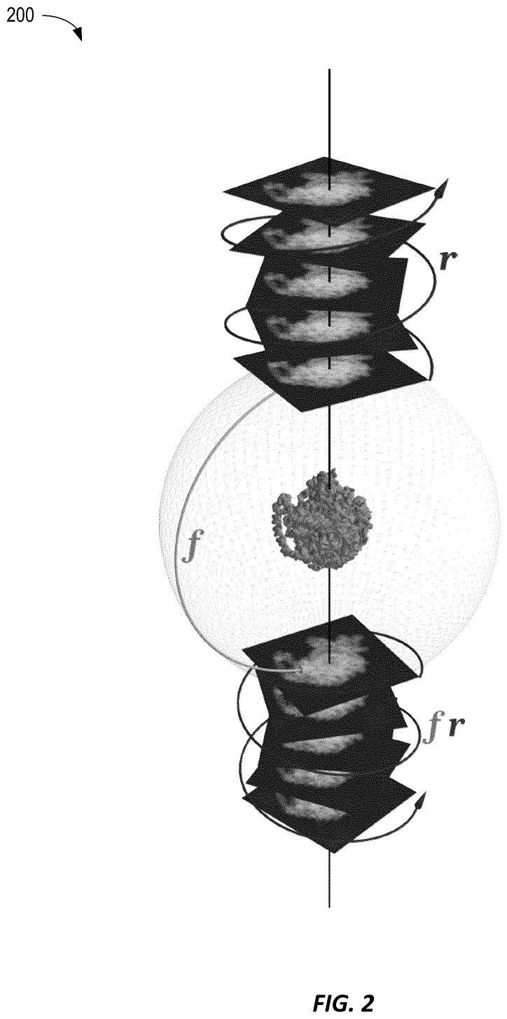

i.e. the projection operator Π is flip equivariant. In other words, projections along a direction (Π(gᵢ⁻¹·Ψ)) are related to projections from the opposite direction (f·Π(rₓgᵢ⁻¹·Ψ)) by a planar reflection f. For example, all projections generated by the bottom view in FIG. 2 (which depicts an example generation process 200 of cryo-EM images in which projections from similar or opposite viewing directions are related by elements of O(2)) are related by a rotation r followed by the reflection f with the images generated from the top view.

That means not only that the relative pose gᵢⱼ≈hᵢⱼ with rᵢⱼ∈R_{z} can be estimated when the viewing directions π(gᵢ) and π(gⱼ) are sufficiently close, but also that hᵢⱼ∈H≅O(2) can be estimated when π(gᵢ)≈˜π(gⱼ), i.e.:

$$\begin{matrix}{h}_{i j} = arg {min}_{h ∈ H ≅ O ( 2 )} {o}_{j} - h . {o}_{{i}_{2}}^{2} & ∀ i , j & s . t . π ( {g}_{i} ) \approx \pm π ( {g}_{j} ) .\end{matrix}$$

where H≅O(2) is the subgroup of SO(3) containing R_{z} (planar rotations along the Z axis) and r_{y}.

The new relative poses {hᵢⱼ∈O(2)}ᵢⱼ still don't fully constrain the absolute poses {gᵢ}ᵢ of the images; indeed, if {ĝᵢ}ᵢ is a solution, then so is {ĝᵢr_{z}}ᵢ, where r_{z}∈R_{z} is a π-rotation around the Z axis:

$${\hat{g}}_{j} \approx {\hat{g}}_{i} {h}_{i j}^{- 1} {\hat{g}}_{j} {r}_{z} \approx {\hat{g}}_{i} {h}_{i j}^{- 1} {r}_{z} {\hat{g}}_{j} {r}_{z} \approx ( {\hat{g}}_{i} {r}_{z} ) {h}_{i j}^{- 1} .$$

This ambiguity is related to a well-known problem: Cryo-EM cannot recover the chirality of a molecule. To see why, let

$$i = [ \begin{matrix}- 1 & 0 & 0 \\ 0 & - 1 & 0 \\ 0 & 0 & - 1\end{matrix} ]$$

be the inversion, i.e. a mirroring along all axes; note that m_{z}=r_{z}i and that i commutes with any element g∈SO(3). Then:

$${o}_{i} = Π ( {g}_{i}^{- 1} . Ψ ) = Π ( {m}_{z} {g}_{i}^{- 1} . Ψ )$$

$$= Π ( {r}_{z} i {g}_{i}^{- 1} . Ψ )$$

$$= Π ( {r}_{z} {g}_{i}^{- 1} . ( i . Ψ ) ) = Π ( {( {g}_{i} {r}_{z} )}^{- 1} . ( i . Ψ ) )$$

i.e., oᵢ is equally likely to be generated by the molecule Ψ with pose gᵢ or its mirrored version i·Ψ with pose gᵢr_{z}. Together with the global SO(3) symmetry introduced earlier, this means Cryo-EM intrinsically suffers from a global O(3) ambiguity which cannot be resolved.

Nevertheless, because r_{z} is the only element of SO(3) commuting with all elements in H≅O(2), relative poses in H constrain the synchronization problem precisely up to this O(3) symmetry and, thus, provide sufficient constraints to identify the images' poses.

### Example Numerical Pose Estimation Method

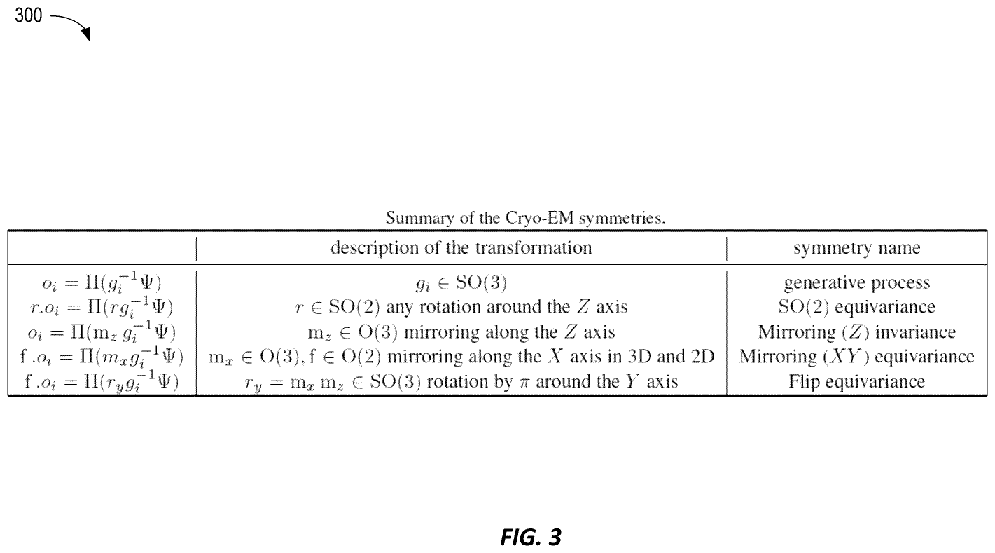

FIG. 3 depicts a table 300 with a summary of the cryo-EM symmetries. In this section, a numerical method to estimate the poses {gᵢ}ᵢ of a set of cryo-EM images {oᵢ}ᵢ is developed by exploiting these and the other previously described symmetries.

One aspect of the methods described herein is the graph connection Laplacian (GCL) of the synchronization graph containing the estimated relative poses {hᵢⱼ∈H≅O(2)}ᵢⱼ on its edges. Under certain conditions, and in the limit of sufficiently many samples (i.e., images), the eigenvalues and the eigenvectors of the GCL converge in probability to the eigenvalues and the eigen-vector-fields of the Laplacian operator defined on the tangent bundle associated with the frame bundle on the projective space defined above.

According to some aspects, a multi-frequency approach may taken to improve robustness to noise. The Laplacian operator on the tangent bundle (which is a vector bundle associated with the standard representation of H≅O(2)) is not directly considered, but rather multiple Laplacian operators defined on vector bundles associated with different irreducible representations (or irrep) of H≅O(2) are considered.

The following provides an overview of one example algorithm.

Initially, (1) let X={oᵢ∈L²( [symbol] ²)}ᵢ₌₁ⁿ be the set of observed images.

Then, (2) for each image i, j, compute hᵢⱼ=arg minₕoⱼ−h·oᵢ_{₂}_{²} and dᵢⱼ=minₕoⱼ−h·oᵢ_{₂}_{²}

Then, (3) define the synchronization graph [symbol] =( [symbol] , ε, [symbol] ) with vertices [symbol] , weighted edge set ε containing an edge between i, j with weight wᵢⱼ=κ(dᵢⱼ) (with κ: [symbol] → [symbol] ⁺ a decaying kernel function, e.g. a Gaussian kernel), and a map [symbol] associating to the edge i, j the estimated relative pose hᵢⱼ.

Then, (4) for each irrep ρ of H≅O(2), build the GCL matrix A^{ρ}, whose block i, j is defined as Aᵢⱼ^{ρ}=wᵢⱼρ(hᵢⱼ)∈ [symbol] ^{dim}^{_{ρ}}^{×dim}^{_{ρ}} if dᵢⱼ<ϵ and 0 otherwise.

Then, (5) compute the eigenvalues decomposition of each GCL matrix A^{ρ} (after normalization), and pick its top eigenvectors and reconstruct a denoised GCL matrix Â^{ρ}.

Then, (6) combine all the denoised GCL matrices {Â^{ρ}}_{ρ} to estimate a denoised relative pose ĥᵢⱼ∈H and weight ŵᵢⱼ∈ [symbol] ⁺ for each edge.

Then, (7) build the GCL associated with the tangent bundle (this is equivalent to the choice of ρ=standard representation) using the relative poses {ĥᵢⱼ}ᵢⱼ just estimated and compute its spectral decomposition.

Then, (8) the 3 top eigen-vector-fields of this Laplacian are interpreted as two vector-fields over the graph's nodes: x: [symbol] → [symbol] ³ and y: [symbol] → [symbol] ³. Then, the two vectors x(i), y(i)∈ [symbol] ³ are interpreted as a choice of basis for the tangent space at i.

Then, (9) if gᵢ=(xᵢ, yᵢ, zᵢ)∈SO(3), then the two columns xᵢ, yᵢ∈ [symbol] ³ define a tangent frame on π(gᵢ)=zᵢ. Because zᵢ=xᵢ×yᵢ, gᵢ can be directly recovered from the reconstructed xᵢ≈x(i) and yᵢ≈y(i).

Then, (10) since x(i) and y(i) are generally not perfectly orthonormal, the reconstructed gᵢ is projected to the closest SO(3) element via SVD.

### Spectral Convergence of Discrete Graph Laplacian

The method described above relies on the assumption that the graph connection Laplacian matrices provide a good approximation of the corresponding Laplacian operators over the vector bundles. Assuming the ground-truth parallel transport is known (1) eigenvectors of normalized (vector) graph connection Laplacian are a discrete approximation of eigen-vector-fields of connection Laplacian operator; and (2) eigenvectors and eigenvalues of normalized (vector) graph connection Laplacian converge to eigenvalues and eigen-vector-fields of connection Laplacian operator.

### Denoising the Graph Connection Laplacians: Estimating Geodesic Distance and Parallel Transport

Ideally, the synchronization graph should resemble a discretization of a frame bundle over the projective plane. The noise on the images negatively affects the estimated distances dᵢⱼ and relative poses hᵢⱼ, potentially introducing “shortcut” edges in this graph. The first step is re-estimating the geodesic distances dᵢⱼ between the points in the graph; this is done by considering the consistency of different paths along the graph between two points. Indeed, because a manifold is locally Euclidean, parallel transport is approximately path-independent within the local neighborhood of a point (considering sufficiently short paths). In other words, the further away two points are, the more inconsistent the cycles through them will be. The GCL A^{ρ} performs parallel-transport of p-vector fields along each edge of the graph; then, (A^{ρ})^{t} transports vectors along each length-t path in the graph. Hence, the block (A^{ρ})ᵢⱼ^{t} will be the average of all length-t paths from i to j. If the paths are mostly inconsistent, (A^{ρ})ᵢⱼ^{t} tends to 0, being the average of uncorrelated orthogonal matrices. This suggests that this matrix can provide useful information about the geodesic distance between i and j.

In the infinite time limit t [symbol] ∞, the (A^{ρ})^{t} converges to its top eigen-space, i.e. (A^{ρ})ᵢⱼ^{t} will be the product of the top eigenvectors of (A^{ρ})^{t}. If ρ is a 2-dimensional irrep of H≅O(2), i.e. has frequency k>0, the top eigen-space of A^{ρ} is 2k+1 dimensional; denote do: ψ_{ρ}: [symbol] → [symbol] ^{2k+1×2} the stack of the top 2k+1 eigen-vectors. Let

$${Â}_{i j}^{ρ} = \frac{\sqrt{2}}{{{ψ}_{ρ} ( j )}_{F}} {{ψ}_{ρ} ( j )}^{T} \frac{\sqrt{2}}{{{ψ}_{ρ} ( i )}_{F}} {ψ}_{ρ} ( i ) .$$

Then, the following identities hold:

$$\frac{1}{2} {( {\hat{A}}^{ρ} )}_{{ij}_{F}}^{2} \approx \frac{1 + {s}_{ij}^{2 k}}{2} + \frac{1 - {s}_{ij}^{2 k}}{2} ,$$

$$det ( {\hat{A}}_{ij}^{ρ} ) \approx \frac{1 + {s}_{ij}^{2 k}}{2} - \frac{1 - {s}_{ij}^{2 k}}{2} ,$$

In particular, by expanding the definition, it holds:

$${S}_{ij}^{k +} := \frac{1 + {s}_{ij}^{2 k}}{2} \approx \frac{1}{4} {( {\hat{A}}^{ρ} )}_{{ij}_{F}}^{2} + \frac{1}{2} det ( {\hat{A}}_{ij}^{ρ} )$$

$${S}_{i j}^{k -} := \frac{1 - {s}_{ij}^{2 k}}{2} \approx \frac{1}{4} {( {\hat{A}}^{ρ} )}_{{ij}_{F}}^{2} - \frac{1}{2} det ( {\hat{A}}_{ij}^{ρ} )$$

$${s}_{ij} \approx {S}_{ij}^{k + \frac{1}{2 k}} - {S}_{ij}^{k - \frac{1}{2 k}}$$

where sᵢⱼ= [symbol] zⱼ, zᵢ [symbol] ∈[−1,1] is the real cosine similarity of π(gᵢ) and π(gⱼ)∈ [symbol] ². The similarity on the projective space that is of interest is ŵᵢⱼ=|sᵢⱼ|. In other words, the top eigen-space of A^{ρ} allows for estimating the geodesic distances dᵢⱼ. The similarities wᵢⱼ^{ρ} estimated using the different A^{ρ} matrices can be combined in different ways to obtain a unique estimation. In practice, for numerical stability, sᵢⱼ may be estimated as:

$${\hat{s}}_{ij} = exp \frac{1}{L} {\sum }_{k = 1}^{L} \frac{1}{2 k} log {S}_{ij}^{k +} - exp \frac{1}{L} {\sum }_{k = 1}^{L} \frac{1}{2 k} log {S}_{i j}^{k -} ,$$

$$or$$

$${\tilde{s}}_{ij} = {\hat{s}}_{ij}^{+} - {\hat{s}}_{ij}^{-} with {\hat{s}}_{ij}^{+} = exp ( \frac{1}{L} {\sum }_{k = 1}^{L} \frac{log {S}_{ij}^{k \pm }}{2 k} )$$

where L is the largest frequency considered. Additionally, note that, due to the decaying spectrum of the Laplacian operators, the noise has a stronger effect on the lowest eigenvalues; discarding the lower eigenvectors also helps denoising the GCL matrices. That means the top eigenvectors of A^{ρ}^{ₖ} may be used to partially denoise the frequency-k parallel transport. In particular, if π(gᵢ)≈±π(gⱼ), the top eigen-space A^{ρ}^{ₖ} produces the exact parallel transport between gᵢ and gⱼ in the block Aᵢⱼ^{ρ}^{ₖ}.

In some cases, however, the following estimation of sᵢⱼ may be preferred, because it may be more robust for the nearest neighbors search:

$${\hat{s}}_{ij} = sign ( {\hat{s}}_{i j}^{+} - {\hat{s}}_{ij}^{-} ) \cdot max ( {\hat{s}}_{i j}^{+} , {\hat{s}}_{i j}^{-} ) , and {\hat{w}}_{i j} = \vert {\hat{s}}_{i j} \vert = max ( {\hat{s}}_{i j}^{+} , {\hat{s}}_{i j}^{-} )$$

Next, all denoised blocks {Aᵢⱼ^{ρ}^{ₖ}}ₖ are combined to estimate the relative pose as

$${\hat{h}}_{i j} = arg {max}_{h} {\sum }_{ρ ∈ \hat{H}} \sqrt{{dim}_{ρ}} {TrA}_{ij}^{ρ} {ρ ( h )}^{T}$$

i.e. the matrices {Aᵢⱼ^{ρ}^{ₖ}}ₖ are interpreted as the Fourier coefficients of a function over H and the element which maximizes this function is picked.

### Tangent Bundle Laplacian

The newly estimated similarity function ŵᵢⱼ and parallel transport ĥᵢⱼ are then used to construct a Laplacian operator on a tangent bundle over the projective space. This is realized as a vector bundle with ρ being the frequency-1 irrep of H≅O(2). With respect to the Laplacian constructed using this irrep in the previous step, the ŵᵢⱼ and ĥᵢⱼ are now used rather than those estimated from the raw images. The top eigen-space of this Laplacian operator is 3 dimensional and its 3 top eigenvectors define a tangent frame at each node in [symbol] in the following way.

Let ψ: [symbol] → [symbol] ^{3×2} be the stack of the top 3 eigen-vectors, define

$$\overline{ψ} ( i ) = \frac{\sqrt{2}}{{ψ ( i )}_{F}} ψ ( i )$$

and let x: [symbol] → [symbol] ³ and y: [symbol] → [symbol] ₃ be its two columns. Then, x(i) and y(i)∈ [symbol] ³ define a basis for the tangent space at π(gᵢ)∈ [symbol] ². Recalling that gᵢ=(xᵢ, yᵢ, zᵢ), x(i) and y(i) approximates respectively xᵢ and yᵢ, while zᵢ can be recovered as zᵢ=xᵢ∈yᵢ. Note also that [symbol] zⱼ, zᵢ [symbol] = [symbol] xⱼ×yⱼ, xᵢ×yᵢ [symbol] =detψ̅ (j)^{T}ψ̅ (j). Note that the solution in output {ĝᵢ=(x(i), y(i), x(i)×y(i))}ᵢ presents the global symmetry previously discussed in the generic cryo-EM setting. Indeed, eigenvalues decomposition is unique up to an orthogonal change of basis in each eigenspace. Since the top eigenspace is 3 dimensional, the solution is unique up to a global g∈O(3) transformation, i.e. if ψ is a set of orthogonal eigenvectors, so is gψ (defined as [gψ](i)=gψ(i)). Hence, all tangent frames {(x(i), y(i))}; can be simultaneously rotated by g. Let g=(i^{c},r)∈O(3), where i is the 3D inversion, c∈{0,1} and r∈SO(3); then det(g)=1−2c and det(g)g=r. By using

$$gx ( i ) \times g y ( i ) = det ( g ) \qquad gx ( i ) \times y ( i ) = r x ( i ) \times y ( i ) ,$$

one can verify that g maps a solution {ĝᵢ}ᵢ to {rĝᵢr_{π}^{c}}ᵢ. Finally, because x(i) and y(i) are not perfectly unitary and orthogonal to each other, the matrix (x(i), y(i), x(i)×y(i)) will not be orthogonal; therefore, it may be projected to the closest SO(3) element via SVD.

### Aspects Related to Computational Complexity

According to some aspects, the techniques disclosed herein may be implemented as a data pipeline. For example, using the MFVDM algorithm with frequencies up to L, assuming that at most M top-eigenvectors of Aₖ may be computed for each frequency k, and assuming a dataset of N images of resolution D×D. The pipeline may consist of three stages: a preprocessing stage, an MFVDM denoising stage, and a synchronization stage. The relative computational complexities of the three stages are described below.

A preprocessing stage may have a computational complexity of O(ND³+NK log N). In this preprocessing stage, a number of invariant features may be built using (fast) steerable principal component analysis (PCA) having computational complexity O(ND³) and the bispectrum, and are used for a K-nearest neighbors (K-NN) search having computational complexity O(NK log N). Then, the O(2) relative alignments of each pair may be estimated in O(ND² log D+NKD²) by leveraging Polar and Fast Fourier Transforms (FFT).

An MFVDM denoising stage may have a computational complexity of O(NLM²+NKLM² log N). In this MFVDM denoising stage, the eigenvalue decomposition of the matrices {Aₖ}ₖ may be accelerated to O(NLM²+NKLM²))≈O(NLM²). The denoised similarities [symbol] cost O(N²). By aggregating multiple frequencies without log, however, a faster K-NN search in O(NKLM² log N) may be used. Finally, the denoised parallel transports hᵢⱼ between neighbors are computed in O(NKL log L) with an FFT. One potential limitation associated with the MFVDM denoising stage is that it assumes uniformly distributed poses (e.g., which may not always be the case in Cryo-EM scenarios). However, renormalization techniques may be leveraged to prevent this assumption from being required.

A synchronization stage may have a computational complexity of O(NK): since the top 3 eigenvectors of A′ are most important, the eigenvalue decomposition only costs O(NK).

The computational complexity of techniques disclosed herein (e.g., when implemented as a data pipeline) may be represented by the sum of the computational complexities of each of the preprocessing stage, the MFVDM denoising stage, and the synchronization stage discussed above.

### Example Process for Pose Estimation

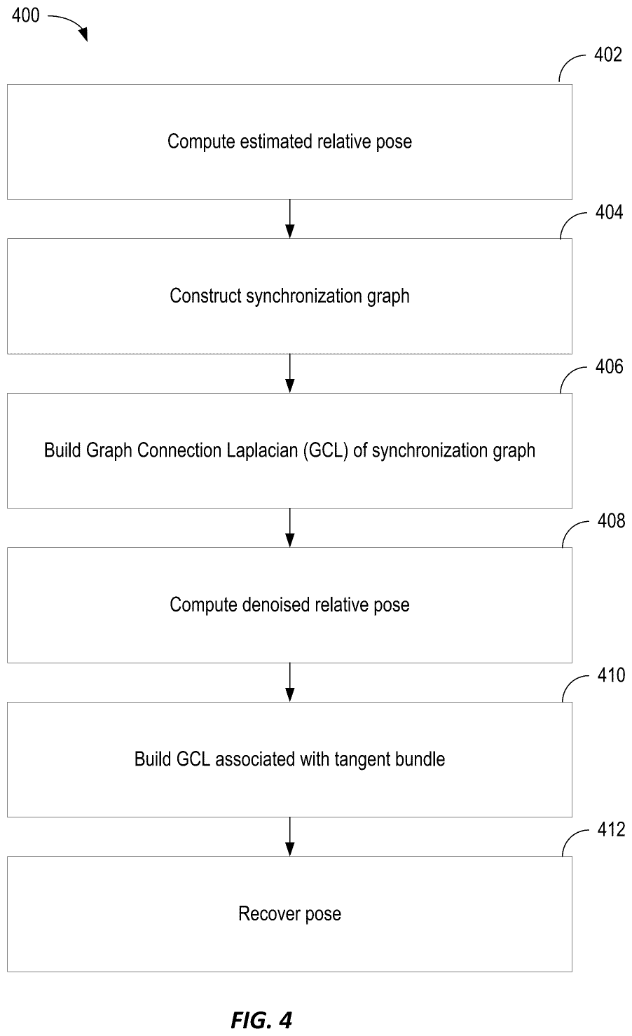

FIG. 4 depicts an example process 400 for image pose estimation from image data, such as, but not limited to, cryo-EM images, as described in conceptual detail above. A set of observations (e.g., images) may be assumed as a starting point for process 400.

At 402, for each pair of observations, estimated relative poses are computed for both of the observations. In some aspects, the estimated relative poses are computed according to the approaches described above. For example, for an observation i, hᵢⱼ is the estimated relative pose from observation i to observation j, and hᵢⱼ∈H where H is set of estimated relative poses.

At 404, a synchronization graph is constructed. The synchronization graph can include a set of vertices, a set of weighted edges and a map. Each vertex can represent an observation, each weighted edge can include weight indicating a measure or a metric of similarity between two observations, and the map can associate each edge to an estimated relative pose.

At 406, graph connection Laplacians (GCLs) of the synchronization graph are built. GCLs of the synchronization graph can include the estimated relative poses on its edges. In some aspects, for each irreducible representations p of H, a GCL matrix is built.

At 408, denoised relative poses are computed. In some aspects, to compute denoised relative poses, eigenvalue decomposition is performed on each of the GCL matrices of the synchronization graph after normalization. Each GCL matrix can have its top eigenvectors determined and used to construct a denoised GCL matrix. All denoised GCL matrices can be combined to estimate a denoised relative pose and a denoised weight for each edge of the synchronization graph.

At 410, a GCL associated with a tangent bundle is built. For example, in the tangent bundle, each observation corresponds to a point on a fiber, (e.g., a point on the base space or the projective plane) together with a choice of orientation of the tangent space at that point. Observations sharing the same viewing direction or having opposite viewing direction live in the same fiber attached to the same point on the base space (projective plane), whereas observations within the same fiber are related by a planar rotation and/or mirroring (e.g., in the form of denoised relative poses) and represent different choices of orientation of the tangent space at that point of the projective plane.

From the tangent bundle, multiple associated vector bundles are constructed, where each vector bundle is associated with a different rotational frequency along the fibers. For each vector bundle, a discretized Vector-Diffusion Laplacian operator is constructed and generates a Laplacian operator matrix.

The Laplacian operator matrices can be denoised via eigenvalue decomposition as similarly discussed above. The denoised Laplacian operator matrices can be combined to recover an estimation of the cosine similarity between the viewing directions of any pair of observations and a denoised estimation of planar rotation and/or mirroring between any two observations with close or opposite viewing directions.

The estimation of the cosine similarity and the denoised estimation of planar rotation and/or mirroring between any two observations with close or opposite viewing directions can be used to build a new denoised Vector-Diffusion Laplacian for the original tangent bundle.

At 412, the top 3 eigenvectors of the denoised Vector-Diffusion Laplacian can be used to compute the poses of each observation in SO(3). For example, the 3 top eigen-vector-fields of the denoised Vector-Diffusion Laplacian can be interpreted as two vector-fields over the sychronization graph's nodes: x: [symbol] → [symbol] ³ and y: [symbol] =→ [symbol] ³. Then, the two vectors x(i), y(i)∈ [symbol] ³ can be interpreted as a choice of basis for the tangent space at for an arbitrary observation i. For a pose gᵢ at i, the rotation about Z-axis can be computed as zᵢ=xᵢ×yᵢ, where xᵢ≈x(i) and yᵢ≈y(i), such that gᵢ=(xᵢ, yᵢ, zᵢ). In some aspects, to ensure that gᵢ=(xᵢ, yᵢ, zᵢ)∈SO(3), gᵢ is projected to SO(3) via singular value decomposition (SVD).

Each image pose gᵢ can then be provided to a 3D reconstruction algorithm as a prior to aid in molecule reconstruction. The 3D reconstruction algorithm can be based on Expectation Maximization (EM). In some aspects, the 3D reconstruction algorithm is a neural network.

Notably, FIG. 4 is just one example of a process consistent with the disclosure herein, and further examples are possible, with additional, fewer, and/or additional steps.

### Example Method of Pose Estimation

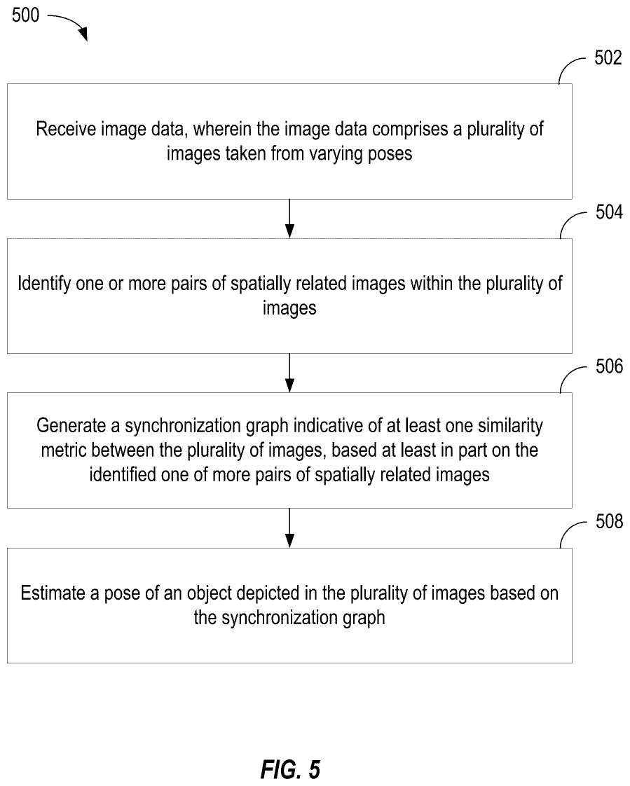

FIG. 5 depicts an example method 500 for pose estimation of image data.

Method 500 begins at step 502 with receiving image data, wherein the image data comprises a plurality of images taken from varying poses.

In some aspects, each pair of the one or more pairs of spatially related images comprises two mirrored images. In some aspects, each pair of the one or more pairs of spatially related images comprises planar rotated images.

In some aspects, the image data comprises electron microscopy image data.

Method 500 then proceeds to step 504 with identifying one or more pairs of spatially related images within the plurality of images.

Method 500 then proceeds to step 506 with generating a synchronization graph indicative of at least one similarity metric between the plurality of images, based at least in part on the identified one of more pairs of spatially related images.

In some aspects, the synchronization graph comprises a plurality of vertices and a plurality of edges, each vertex in the plurality of vertices indicates an image, and each edge in the plurality of edges indicates a similarity metric between two images of the plurality of images.

In some aspects, the similarity metric indicates a maximum similarity between the two images of the plurality of images.

Method 500 then proceeds to step 508 with estimating a pose of an object depicted in the plurality of images based on the synchronization graph. In some aspects, the pose is an SO(3) pose.

In some aspects, estimating the pose of the object depicted in the plurality of images further comprises: generating one or more matrices indicative of the synchronization graph; denoising the one or more matrices; and estimating the pose of the object based on the one or more matrices.

In some aspects, estimating the pose of the object based on the plurality of tangent bundles comprises performing an eigenvalue decomposition.

In some aspects, the object is a molecule.

In some aspects, method 500 further includes providing the estimated pose of the object to a 3D reconstruction algorithm.

In some aspects, the 3D reconstruction algorithm is based on Expectation Maximization (EM). In some aspects, the 3D reconstruction algorithm comprises a neural network.

In some aspects, the one of more matrices comprise Graph-Connection Laplacians (GCLs), and each GCL associated with the one or more matrices is indicative of a frequency of the images.

In some aspects, estimating the pose of the object further comprises computing top three eigenvectors of the tangent bundle, computing two bases based on the eigenvectors and computing a third basis based on the two bases.

In some aspects, estimating the pose of the object based on the one or more matrices includes combining the denoised one or more matrices to estimate a denoised relative pose and a denoise weight for each edge in the synchronization graph; constructing a tangent bundle for each image in the plurality of images, wherein the tangent bundle is a fiber bundle; constructing one or more vector bundles associated with the tangent bundle; for each of the one or more vector bundles, constructing a discretized Vector-Diffusion Laplacian operator; denoising the one or more discretized Vector-Diffusion the Laplacian operator; constructing a denoised Vector-Diffusion Laplacian for the tangent bundle based on denoising the one or more discretized Vector-Diffusion the Laplacian; determining top eigenvector-fields of denoised Vector-Diffusion Laplacian for the tangent bundle; and generating the pose of each of the plurality of images based on the top eigenvector-fields determined.

### Example Processing System

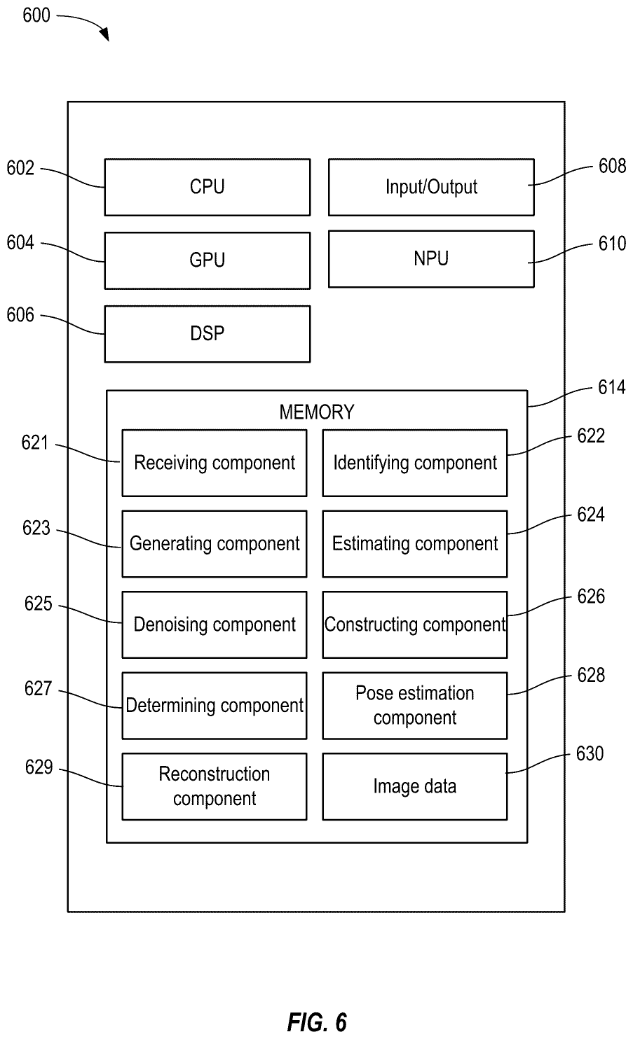

FIG. 6 is a block diagram illustrating a processing system 600 which may be configured to perform aspects of the various methods described herein, including, for example, the methods described with respect to FIGS. 4 and 5.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 614.

Processing system 600 also includes additional processing components tailored to specific functions, such as, but not limited to, a graphics processing unit (GPU) 604, a digital signal processor (DSP) 606, and a neural processing unit (NPU) 610.

Though not depicted in FIG. 6, NPU 610 may be implemented as a part of one or more of CPU 602, GPU 604, and/or DSP 606.

The processing system 600 also includes input/output 608. In some aspects, the input/output 608 can include one or more network interfaces, allowing the processing system 600 to be coupled to a one or more other devices or systems via a network (such as, but not limited to, the Internet).

Although not included in the illustrated aspect, the processing system 600 may also include one or more additional input and/or output devices 608, such as, but not limited to, screens, physical buttons, speakers, microphones, and the like.

Processing system 600 also includes memory 614, which is representative of one or more static and/or dynamic memories, such as, but not limited to, a dynamic random access memory, a flash-based static memory, and the like. In this example, the memory 614 includes computer-executable components, which may be executed by one or more of the aforementioned processors of the processing system 600.

In this example, the memory 614 includes receiving component 621, identifying component 622, generating component 623, estimating component 624, denoising component 625, constructing component 626, determining component 627, pose estimation component 628, reconstruction component 629, and image data 630.

Generally, the components depicted in the memory 614 may be configured to perform various methods described herein, including those described with respect to FIGS. 4 and 5.

Note that the processing system 600 is just one example, and further examples with additional, fewer, or alternative components are possible.

### Example Clauses

Implementation examples are described in the following numbered clauses:

Clause 1: A computer-implemented method, comprising: receiving image data, wherein the image data comprises a plurality of images taken from varying poses; identifying one or more pairs of spatially related images within the plurality of images; generating a synchronization graph indicative of at least one similarity metric between the plurality of images, based at least in part on the identified one of more pairs of spatially related images; and estimating a pose of an object depicted in the plurality of images based on the synchronization graph.

Clause 2: The method of Clause 1, wherein each pair of the one or more pairs of spatially related images comprises two mirrored images.

Clause 3: The method of Clause 1, wherein each pair of the one or more pairs of spatially related images comprises planar rotated images.

Clause 4: The method of any one of Clauses 1-3, wherein the pose is an SO(3) pose.

Clause 5: The method of any one of Clauses 1-4, further comprising providing the estimated pose of the object to a 3D reconstruction algorithm.

Clause 6: The method of any one of Clauses 1-5, wherein estimating the pose of the object depicted in the plurality of images further comprises: generating one or more matrices indicative of the synchronization graph; denoising the one or more matrices; and estimating the pose of the object based on the one or more matrices.

Clause 7: The method of any one of Clauses 1-6, wherein: the synchronization graph comprises a plurality of vertices and a plurality of edges, each vertex in the plurality of vertices indicates an image, and each edge in the plurality of edges indicates a similarity metric between two images of the plurality of images.

Clause 8: The method of Clause 7, wherein the similarity metric indicates a maximum similarity between the two images of the plurality of images.

Clause 9: The method of Clause 5, wherein the 3D reconstruction algorithm is based on Expectation Maximization (EM).

Clause 10: The method of Clause 5, wherein the 3D reconstruction algorithm comprises a neural network.

Clause 11: The method of Clause 6, wherein: the one of more matrices comprise Graph-Connection Laplacians (GCLs), and each GCL associated with the one or more matrices is indicative of a frequency of the images.

Clause 12: The method of Clause 6, wherein estimating the pose of the object based on the plurality of tangent bundles comprises performing an eigenvalue decomposition.

Clause 13: The method of any one of Clauses 1-12, wherein the image data comprises electron microscopy image data.

Clause 14: The method of Clause 13, wherein the object is a molecule.

Clause 15: The method of Clause 6, wherein estimating the pose of the object further comprises computing top three eigenvectors of the tangent vector bundle, computing two bases based on the eigenvectors and computing a third basis based on the two bases.

Clause 16: The method of Clause 6, wherein estimating the pose of the object based on the one or more matrices comprises: combining the denoised one or more matrices to estimate a denoised relative pose and a denoise weight for each edge in the synchronization graph; constructing a tangent bundle for each image in the plurality of images, wherein the tangent bundle is a fiber bundle; constructing one or more vector bundles associated with the tangent bundle; for each of the one or more vector bundles, constructing a discretized Vector-Diffusion Laplacian operator; denoising the one or more discretized Vector-Diffusion the Laplacian operator; constructing a denoised Vector-Diffusion Laplacian for the tangent bundle based on denoising the one or more discretized Vector-Diffusion the Laplacian; determining top eigenvector-fields of denoised Vector-Diffusion Laplacian for the tangent bundle; and generating the pose of each of the plurality of images based on the top eigenvector-fields determined.

Clause 17: A processing system, comprising: a memory comprising computer-executable instructions; one or more processors configured to execute the computer-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium comprising computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving image data, wherein the image data comprises a plurality of images taken of varying poses;
identifying one or more pairs of spatially related images within the plurality of images;
generating a synchronization graph indicative of at least one similarity metric between the plurality of images, based at least in part on the identified one of more pairs of spatially related images; and
estimating a pose of an object depicted in the plurality of images based on the synchronization graph.

2. The method of claim 1, wherein each pair of the one or more pairs of spatially related images comprises two mirrored images.

3. The method of claim 1, wherein each pair of the one or more pairs of spatially related images comprises planar rotated images.

4. The method of claim 1, wherein the pose is an SO(3) pose.

5. The method of claim 1, further comprising providing the estimated pose of the object to a 3D reconstruction algorithm.

6. The method of claim 5, wherein the 3D reconstruction algorithm is based on Expectation Maximization (EM).

7. The method of claim 5, wherein the 3D reconstruction algorithm comprises a neural network.

8. The method of claim 1, wherein estimating the pose of the object depicted in the plurality of images further comprises:
generating one or more matrices indicative of the synchronization graph;
denoising the one or more matrices; and
estimating the pose of the object based on the one of more matrices.

9. The method of claim 8, wherein:
the one of more matrices comprise Graph-Connection Laplacians (GCLs), and
each GCL associated with the one or more matrices is indicative of a frequency of the images.

10. The method of claim 8, wherein estimating the pose of the object based on the plurality of images comprises performing an eigenvalue decomposition.

11. The method of claim 8, wherein estimating the pose of the object further comprises computing top three eigenvectors of a tangent vector bundle, computing two bases based on the eigenvectors and computing a third basis based on the two bases.

12. The method of claim 8, wherein estimating the pose of the object based on the one or more matrices comprises:
combining the denoised one or more matrices to estimate a denoised relative pose and a denoise weight for each edge in the synchronization graph;
constructing a tangent bundle for each image in the plurality of images, wherein the tangent bundle is a fiber bundle;
constructing one or more vector bundles associated with the tangent bundle;
for each of the one or more vector bundles, constructing a discretized Vector-Diffusion Laplacian operator;
denoising the one or more discretized Vector-Diffusion Laplacian operators;
constructing a denoised Vector-Diffusion Laplacian for the tangent bundle based on denoising the one or more discretized Vector-Diffusion Laplacian operators;
determining top eigenvector-fields of denoised Vector-Diffusion Laplacian for the tangent bundle; and
generating the pose of each of the plurality of images based on the top eigenvector-fields determined.

13. The method of claim 1, wherein:
the synchronization graph comprises a plurality of vertices and a plurality of edges,
each vertex in the plurality of vertices indicates an image, and
each edge in the plurality of edges indicates a similarity metric between two images of the plurality of images.

14. The method of claim 13, wherein the similarity metric indicates a maximum similarity between the two images of the plurality of images.

15. The method of claim 1, wherein the image data comprises electron microscopy image data.

16. The method of claim 15, wherein the object is a molecule.

17. An apparatus, comprising: a memory comprising computer-executable instructions; and a processor configured to execute the computer-executable instructions and cause the apparatus to:
receive image data, wherein the image data comprises a plurality of images taken of varying poses;
identify one or more pairs of spatially related images within the plurality of images;
generate a synchronization graph indicative of at least one similarity metric between the plurality of images, based at least in part on the identified one of more pairs of spatially related images; and
estimate a pose of an object depicted in the plurality of images based on the synchronization graph.

18. The apparatus of claim 17, wherein each pair of the one or more pairs of spatially related images comprises two mirrored images.

19. The apparatus of claim 17, wherein each pair of the one or more pairs of spatially related images comprises planar rotated images.

20. The apparatus of claim 17, wherein the pose is an SO(3) pose.

21. The apparatus of claim 17, wherein the processor is further configured to execute the computer-executable instructions and cause the apparatus to provide the estimated pose of the object to a 3D reconstruction algorithm.

22. The apparatus of claim 21, wherein the 3D reconstruction algorithm is based on Expectation Maximization (EM).

23. The apparatus of claim 17, wherein estimating the pose of the object depicted in the plurality of images further comprises:
generating one or more matrices indicative of the synchronization graph;
denoising the one or more matrices; and
estimating the pose of the object based on the one of more matrices.

24. The apparatus of claim 23, wherein estimating the pose of the object based on the plurality of images comprises performing an eigenvalue decomposition.

25. The apparatus of claim 23, wherein estimating the pose of the object further comprises computing top three eigenvectors of a tangent vector bundle, computing two bases based on the eigenvectors and computing a third basis based on the two bases.

26. The apparatus of claim 23, wherein estimating the pose of the object based on the one or more matrices comprises:
combining the denoised one or more matrices to estimate a denoised relative pose and a denoise weight for each edge in the synchronization graph;
constructing a fiber bundle representing the plurality of images;
constructing one or more vector bundles associated with the fiber bundle;
for each of the one or more vector bundles, constructing a discretized Vector-Diffusion Laplacian operator;
denoising the one or more discretized Vector-Diffusion Laplacian operators;
constructing a denoised Vector-Diffusion Laplacian for the fiber bundle based on denoising the one or more discretized Vector-Diffusion Laplacian operators;
determining top eigenvector-fields of denoised Vector-Diffusion Laplacian for the fiber bundle; and
generating the pose of each of the plurality of images based on the top eigenvector-fields determined.

27. The apparatus of claim 17, wherein:
the synchronization graph comprises a plurality of vertices and a plurality of edges,
each vertex in the plurality of vertices indicates an image,
each edge in the plurality of edges indicates a similarity metric between two images of the plurality of images, and
the similarity metric indicates a maximum similarity between the two images of the plurality of images.

28. The apparatus of claim 17, wherein:
the image data comprises electron microscopy image data; and
the object is a molecule.

29. An apparatus for wireless communication at a user equipment (UE), comprising:
means for receiving image data, wherein the image data comprises a plurality of images taken of varying poses;
means for identifying one or more pairs of spatially related images within the plurality of images;
means for generating a synchronization graph indicative of at least one similarity metric between the plurality of images, based at least in part on the identified one of more pairs of spatially related images; and
means for estimating a pose of an object depicted in the plurality of images based on the synchronization graph.

30. A computer readable medium having instructions stored thereon for:
receiving image data, wherein the image data comprises a plurality of images taken of varying poses;
identifying one or more pairs of spatially related images within the plurality of images;
generating a synchronization graph indicative of at least one similarity metric between the plurality of images, based at least in part on the identified one of more pairs of spatially related images; and
estimating a pose of an object depicted in the plurality of images based on the synchronization graph.
